(19) United States
(12) Patent Application Publication
(10) Pub. No.: US 2011/0092644 A1
(43) Pub. Date: Apr. 21, 2011

(54) AQUEOUS DISPERSION POLYMERIZATION PROCESS FOR ETHYLENE/TETRAFLUOROETHYLENE COPOLYMER

(75) Inventors: Ralph Munson Aten, Chadds Ford, PA (US); Heidi Elizabeth Burch, Parkersburg, WV (US)

(73) Assignee: E.I. DU PONT DE NEMOURS AND COMPANY, Wilmington, DE (US)

(21) Appl. No.: 12/999,416

(22) PCT Filed: Jun. 25, 2009
(86) PCT No.: PCT/US09/48593

§ 371 Date: Dec. 16, 2010

Related U.S. Application Data
(60) Provisional application No. 61/079,506, filed on Jul. 10, 2008.

(51) Int. Cl. C08J 3/03; B82Y 40/00

(52) U.S. Cl. 524/805; 977/773

(57) ABSTRACT

A polymerization process is provided to form a copolymer of ethylene with tetrafluoroethylene and a modifying monomer having a side chain containing at least two carbon atoms by initiating the polymerization in an aqueous medium with a fluoromonomer that forms a stable dispersion of polymer particles from the fluoromonomer in the aqueous medium, which forms polymerization sites for further polymerization, and carrying the further polymerization by copolymerizing the ethylene, tetrafluoroethylene, and modifying monomer as a dispersion in at least said aqueous medium to a polymer solids content of at least 15 wt %, said copolymer comprising at least 60 wt % of the total polymer content of the polymer solids.

### BACKGROUND OF THE INVENTION

1. Field of the Invention

This invention relates to the polymerization process to form ethylene/tetrafluoroethylene copolymer.

2. Description of Related Art

U.S. Pat. No. 3,624,250 (Carlson) discloses the copolymerization of ethylene (E) with tetrafluoroethylene (TFE) and a small amount of vinyl monomer that provides a side chain having at least two carbon atoms in a non-aqueous polymerization medium, i.e. in an organic solvent such as F-113 (1,1,2-trichloro-1,2,2-trifluoroethane), to form ETFE. The vinyl monomer is a modifier in the ETFE copolymer, i.e. the vinyl monomer improves the high temperature tensile properties as compared to ETFE dipolymer. For environmental reasons, it has become undesirable to carry out the polymerization in an organic solvent. Replacement of this polymerization medium with water has been difficult, in the sense that the aqueous dispersion is unstable such that the ETFE polymer particles tend to coagulate at low solids content during polymerization rather than stay dispersed in the aqueous medium. U.S. Pat. No. 4,338,237 (Sulzbach et al.) discloses that it is not possible to prepare stable aqueous dispersions of ETFE copolymer under conditions that are customary for the polymerization of TFE to form stable aqueous dispersions of polytetrafluoroethylene (PTFE) unless organic solvent stabilizer is also present in the aqueous medium (col. 1, I. 47-59). The presence of modifying vinyl monomer such as disclosed in Carlson worsens the coagulum problem in aqueous dispersion polymerization of E and TFE.

### SUMMARY OF THE INVENTION

The present invention provides an aqueous dispersion polymerization process for making a copolymer of ethylene/-tetrafluoroethylene/vinyl monomer providing a side chain containing at least two carbon atoms, wherein the dispersion is stable. Thus, the present invention is a process for polymerization to form a copolymer of ethylene/tetrafluoroethylene/modifying vinyl monomer providing a side chain containing at least two carbon atoms as a dispersion of particles of said copolymer in an aqueous medium, comprising (a) initiating said polymerization with at least one fluoromonomer that forms a stable dispersion of thermally stable polymer particles in said aqueous medium, said thermally stable polymer particles providing polymerization sites for further polymerization and (b) carrying out said further polymerization by copolymerizing said ethylene, tetrafluoroethylene, and modifying vinyl monomer in at least said aqueous medium to a polymer solids content of at least about 15 wt %, said copolymer comprising at least about 60 wt % of the total polymer content of said polymer solids.

The fluoromonomer polymerizes to a fluoropolymer that is a different polymer than the copolymer of E/TFE/vinyl monomer, and is chosen for its greater dispersion stability than if the ethylene, TFE, and vinyl monomer were copolymerized without the polymer particles from the polymerized fluoromonomer being present. One effect of the initiation of the polymerization with the fluoromonomer is that the addition of the vinyl monomer modifier to the polymerization medium is delayed, i.e. the fluoromonomer is polymerized first before the ethylene, tetrafluoroethylene, vinyl monomer copolymerization is begun. This delay in introducing the vinyl monomer to the polymerization medium has the beneficial effect of preventing the vinyl monomer from causing dispersion instability as would be the case if the vinyl monomer were present from the start of polymerization. Thus, the present invention achieves improved dispersion stability in the aqueous polymerization medium by initiating the polymerization process to form a stable dispersion of fluoropolymer particles and by delaying the addition to and polymerization of the vinyl monomer modifier.

Another beneficial effect of the steps (a) and (b) of the polymerization process is that the resultant polymer particles after completion of steps (a) and (b) contain both the polymer derived by polymerization of the fluoromonomer of step (a) and the copolymer derived from the copolymerization of step (b). This association of different polymers in the same particle, while still having the character of ETFE copolymer by virtue of its wt % predominance, provides a vehicle for introducing the fluoromonomer-derived polymer, especially when the monomer of step (a) is perfluoromonomer, into other fluoropolymers to provide constructive modification of such other fluoropolymers as will described hereinafter. The greater dispersion stability of the fluoropolymer particles confers dispersion stability on the ETFE formed on the fluoropolymer particles.

The process of the present invention is carried out in the presence of free-radical initiator and surfactant, with the surfactant being in an effective amount to obtain the desired dispersion stability. The dispersed polymer particles obtained at the completion of step (b) are stabilized, i.e. remain dispersed, in the aqueous medium by the surfactant without requiring an excessive amount thereof. The process is also carried out in the essential absence of organic solvent stabilizer. Preferably no organic solvent is added to the polymerization medium. By the essential absence of such solvent is meant that if a small amount is added, any advantage in dispersion stability arising from this addition is outweighed by disadvantage in the addition, arising e.g. from the need to procure, store, and recover the added organic solvent. Such addition would be without practical effect.

Contributing to the greater dispersion stability obtained by the present invention is the very small size of the polymer particles obtained upon completion of step (b). Such particles have an average size of no greater than about 125 nm and typically no greater than about 100 nm. These small polymer particle sizes are obtained even at the substantial solids concentration reached by the polymerization process, e.g. at least about 15 wt % polymer solids based on the total weight of the polymer solids and aqueous polymerization medium. The fluoropolymer particles obtained by step (a) will have an even smaller average particle size, preferably no greater than about 60 nm and typically, no greater than about 50 nm. The minimum number or amount of polymer particles obtained by step (a) is that which is effective to improve the dispersion stability of the resultant copolymer of E/TFE/vinyl monomer as compared to when these monomers are copolymerized in the absence of step (a). The fluoropolymer formed in step (a) should constitute at least about 1 wt % of the total polymer content, whereby the step (b) copolymer would constitute about 99 to 60 wt % of the total polymer content.

In one embodiment of the present invention, the polymer obtained upon completion of both steps (a) and (b) is present as particles constituting the dispersed phase in an aqueous medium. Such polymer will be present in the aqueous dispersion medium as primary (as-polymerized) particles having the particle sizes mentioned above. Such polymer can have other forms, such as the coagulate formed from coagulating the dispersion of such polymer particles, i.e. a coagulate of the primary particles. This coagulate can be dried to form agglomerates (secondary particles) of primary particles and in this way, the primary particles as agglomerates can be exposed to melt mixing, such as in an extruder, either to form a fabricated article in final form or pellets of the polymer. The resultant melt mixture comprises a dispersion of the fluoropolymer of step (a) in a matrix of the copolymer of E/TFE/vinyl monomer. The process of melt mixing can be carried out in the presence of additional copolymer of E/TFE/vinyl monomer, wherein this copolymer blends with the E/TFE/vinyl monomer from step (b) to form the matrix of the resultant melt blend, within which the fluoropolymer from step (a) is dispersed. The process of melt mixing can also be carried out in the presence of melt-fabricable perfluoropolymers, wherein both the fluoropolymer from step (a) and the copolymer of E/TFE/vinyl monomer become dispersed in the matrix of the perfluoropolymer.

### DETAILED DESCRIPTION

The fluoromonomer polymerized in step (a) is preferably perfluoromonomer and preferably comprises TFE. Preferably the fluoropolymer formed in step (a) is polytetrafluoroethylene (PTFE). In one embodiment of the present invention, the aqueous dispersion polymerization in step (a) is the fine powder type, which is the preferred type of PTFE obtained by the step (a) of the polymerization process. The fine powder type of PTFE has such a high molecular weight, e.g. at least 1,000,000, that it does not flow in the molten state. If the polymerization is stopped after TFE polymerization has occurred, i.e. completion of step (a) and the resultant PTFE is isolated and tested for flow property, such as by the test procedure of ASTM D 1238-94a involving the forcing (5 kg weight) of molten polymer through an orifice, the molten PTFE at 380° C. does not flow through the orifice. Such PTFE also has a high melt creep viscosity, sometimes called specific melt viscosity, which involves the measurement of the rate of elongation of a molten sliver of PTFE under a known tensile stress for 30 min, as further described in and determined in accordance with U.S. Pat. No. 6,841,594, referring to the specific melt viscosity measurement procedure of U.S. Pat. No. 3,819,594. In this test, the molten sliver made in accordance with the test procedure is maintained under load for 30 min, before the measurement of melt creep viscosity is begun, and this measurement is then made during the next 30 min of applied load. The PTFE preferably has a melt creep viscosity of at least about 1×10⁶ Pa·s, more preferably at least about 1×10⁷ Pa·s, and most preferably at least about 1×10⁸ Pa·s, all at 380° C. This temperature is well above the first and second melt temperatures of PTFE of 343° C. and 327° C., respectively.

The PTFE obtained from step (a) can be homopolymer of tetrafluoroethylene or a copolymer thereof with a small amount of comonomer, such as hexafluoropropylene or perfluoro(alkyl vinyl ether) (PAVE) wherein the alkyl group can be linear or branched and contains 1 to 5 carbon atoms, that improves the sinterability of the TFE, to obtain such improvement as reduced permeability and greater flex life, as compared to the TFE homopolymer. The comonomer-modified PTFE is sometimes referred to simply as modified PTFE. Examples of modified PTFE are disclosed in U.S. Pat. Nos. 3,142,665, 3,819,594, and 6,870,020 and this modified PTFE can be used as the step (a) fluoropolymer obtained by the process of the present invention. The '665 and '594 patents disclose the very small modifier contents in the PTFE, within the range of 0.05 to 0.3 wt %, and the '020 patent discloses higher modifier contents of about 0.5 to 10 wt %. For simplicity and because the modified PTFE exhibits the same non-melt flow, high melt creep viscosity of PTFE homopolymer, this type of PTFE is included in the term polytetrafluoroethylene or PTFE used herein.

In another embodiment of the present invention the fluoromonomer polymerized in step (a) includes an additional monomer, namely ethylene in an amount that provides a fluoropolymer containing 40 to 60 mole %, total 100 mole %, of units derived from the copolymerization of each of these monomers. According to this embodiment, the resultant ETFE particles formed are a dipolymer of ethylene and tetrafluoroethylene, i.e. no modifying monomer is present in step (a). A dispersion of ETFE dipolymer particles has greater stability than a dispersion of copolymer of ethylene/tetrafluoroethylene/modifying monomer, whereby the dipolymer particles confer its greater dispersion stability to the ethylene/tetrafluoroethylene/vinyl monomer copolymerized onto said particles in step (b).

The fluoropolymer from step (a) is present as dispersed particles in the aqueous medium within which the copolymerization step (b) is carried out, whereby the polymer resulting from the process of the present invention is a bicomponent polymer in which the fluoropolymer from step (a) is the core onto which is formed the copolymer of E/TFE/vinyl monomer as the shell, whereby the polymer particles obtained from completion of steps (a) and (b) are core/shell polymer particles dispersed in the aqueous polymerization medium. The copolymers of ethylene with TFE typically contain about 40 to 60 mol % of each monomer, i.e. repeat units —CH₂—CH₂— and —CF₂—CF₂—, respectively derived from these monomers, to total 100 mol % of the combination of these monomer units. The modifying monomer is one that is copolymerizable with the ethylene and TFE and is free of telogenic activity in the sense of not acting as a chain transfer agent. These aspects of polymerizability and freedom from telogenic activity are further disclosed in U.S. Pat. No. 3,624,250, which disclosure is applicable to the present invention. Preferred modifying vinyl monomers providing at least two carbon atoms in the side chain of the repeat unit derived from copolymerization of the vinyl monomer are (i) CF₂═CFOₓR, wherein x is an integer of 0 or 1 and R is an organic group containing at least 2 carbon atoms, preferably fluoroalkyl containing 2 to 6 carbon atoms, more preferably perfluoroalkyl, (ii) CH₂═CHₓR′_{y}, wherein x is an integer of 0 or 1 and y is 2 or 1, respectively, and R′ is fluoroalkyl, preferably containing 2 to 6 carbon atoms, more preferably perfluoroalkyl and (iii) CH₂═CFR″ wherein R″ is fluoroalkyl, preferably C₂-C₁₀ fluoroalkyl. The R, R′, and R″ groups form the side chain containing at least 2 carbon atoms. Examples of these vinyl monomers are perfluoroalkyl ethylene, preferably perfluorobutyl ethylene and perfluoro(alkyl vinyl ether), such as perfluoro(ethyl or propyl vinyl ether), hexafluoroisobutylene, and CH₂═CFC₅F₁₀H. Typically, about 0.1 to 10 mol % of the copolymer will be the modifying monomer. Examples of copolymers of E/TFE/vinyl monomer having at least two side chain carbon atoms are further described in U.S. Pat. Nos. 3,624,250, 4,123,602, 4,513,129, and 4,677,175. When the modifying vinyl monomer has only one carbon atom in the side chain such as is provided by hexafluoropropylene, the increased difficulty in obtaining a stable aqueous polymer dispersion is not present.

The aqueous dispersion polymerization of the present invention uses free radical initiator to cause the polymerization to occur and surfactant to disperse the polymer particles as they are formed in the aqueous medium in both steps (a) and (b). The copolymerization step (b) of the process is preferably carried out in the presence of chain transfer agent (CTA), such as an alkane, such as ethane.

The initiator used to form the fluoropolymer of step (a) will generally also be used to form the copolymer of step (b). Examples of initiators used in both polymerizations are the acids and salts of manganese, such as disclosed in U.S. Pat. No. 3,859,262, such as the alkali metal and alkaline earth metal salts of permanganic acid. Examples of such salts are potassium permanganate and sodium permanganate. Preferably reducing agent is used in combination with this initiator, such as oxalic acid or a bisulfite such as sodium bisulfite.

Examples of dispersing agents used in the aqueous dispersion polymerizations include ammonium perfluorooctanoic and perfluoroalkyl ethane sulfonic acid salts, such as the ammonium salt. The concentration of surfactant in the aqueous medium is typically less than 0.4 wt % based on the weight of the aqueous medium.

By virtue of the fluoropolymer particles resulting from step (a) being small, for example having an average particle size of no more than 60 nm, preferably no more than 50 nm, the growth of these particles during step produces small overall polymer particles, preferably having an average particle size of no more than 90 nm. One method for obtaining the small fluoropolymer particles in step (a) is the use of the combination of fluorosurfactants such as disclosed in U.S. Pat. No. 6,395,848, which is a mixture of (i) a fluoroalkyl acid (carboxylic or sulfonic) or salt, such as ammonium perfluorooctanoate and (ii) a perfluoropolyether acid (carboxylic or sulfonic) or salt such as the PFPE-1 to -7 disclosed in Table 1 (col. 13) of the patent. Preferably, the amount of (i) is less than 5 wt % of the combined weight of (i) and (ii).

The surfactant present in the aqueous medium maintains a stable dispersion of the polymer particles until the polymerization reaction is completed to obtain the solids content in the aqueous medium desired. Preferably the polymer particles from steps (a) and (b) constitute at least about 20 wt % of the combined weight of the aqueous medium and the polymer particles. The dispersed polymer particles can be intentionally coagulated, by such conventional means as increased agitation from the agitation applied during polymerization or by addition of electrolyte. Alternatively, the coagulation can be done by freeze/thaw method such as disclosed in U.S. Pat. No. 5,708,131 (Morgan).

A general description for carrying out the process of the present invention involves the steps of precharging an aqueous medium to a stirred autoclave, deoxygenating the autoclave, pressurizing with the fluoromonomer of step (a) to a predetermined level, adding modifying comonomer if desired if the fluoromonomer is TFE, agitating, bringing the system to desired temperature, e.g., 60°-100° C., introducing initiator, adding more fluoromonomer according to predetermined basis depending on the content of the fluoropolymer from step (a) desired in the final polymer, and regulating temperature, initiator addition, at the same or different rate, throughout the polymerization or only for part of the polymerization. Recipe and operating parameters not fixed by the equipment are commonly selected in order that temperature is maintained approximately constant throughout the polymerization. This same general procedure is followed for copolymerizing the ethylene, TFE, and vinyl monomers in step (b), except that the polymerization temperature and order of addition of the monomers will depend on the identity of the vinyl monomer. The transition between the polymerization from step (a) to step (b) can be as shown in the Examples. The timing of the transition is set in order to obtain the desired weight proportion of fluoropolymer from step (a) and copolymer from step (b) forming the resultant polymer particles dispersed in the aqueous polymerization medium. The weight % of the fluoropolymer from step (a) can be determined by comparing the weight of fluoromonomer consumed in the polymerization of step (a) with the weight of the monomers consumed in the polymerization of step (b). Preferably, this transition is practiced by stopping the polymerization upon completion of step (a) and then establishing the polymerization conditions for step (b). The transition can be carried out in a separate reactor, to which the aqueous dispersion of fluoropolymer particles is transferred to act as a seed for the copolymerization of the copolymer in step (b). In any event, the transition between polymerization of step (a) to the polymerization of step (b) provides intimacy between the incompatible polymers formed in these steps.

The content of the copolymer of E/TFE/vinyl monomer in the polymer obtained from steps (a) and (b) of the polymerization process of the present invention is controlled and will depend on the intended use of the polymer. When used as an additive for melt blending with other melt-fabricable fluoropolymer, the copolymer content is preferably at least about 60 wt % of the total polymer content; the melt flowability of the melt-fabricable fluoropolymer enables the polymer obtained from steps (a) and (b) having high step (a) polymer content to be melt blended. When used for melt blending with itself, i.e. the polymer obtained by the process of the present invention is melt blended with no other polymer being present, the copolymer content is preferably at least 72 wt %, more preferably at least 75 wt %. The resultant polymer can be used in the same manner as ETFE copolymer. In all cases, when the polymer obtained from step (a) is a perfluoropolymer, the lower density of the polymer obtained from step (b) results in the vol % of the copolymer being greater than the wt %. For example, when the fluoropolymer of step (a) is PTFE, 75 wt % copolymer content formed in step (b) corresponds to more than 80 vol % of the copolymer being present in the polymer formed from both steps. Preferably, the amount of fluoropolymer formed in step (a) is at least about 2 wt %.

When the fluoropolymer obtained from step (a) is the non-melt flowable PTFE, as is the PTFE polymerized in step (a) in the Examples 1-4 herein, the eventual melt blending of the polymer obtained from steps (a) and (b) will result in these PTFE particles being the dispersed phase in a matrix of the melt-fabricable fluoropolymers present in the melt blending. When the matrix polymer is melt-fabricable perfluoropolymer, both polymers made during the polymerization process of the present invention become dispersed in the perfluoropolymer matrix. As will be shown in the Examples, the polymer made by the process of the present invention produces surprising results. When incorporated by melt blending into ETFE copolymer, the flex modulus of the ETFE is reduced. Just the opposite occurs when the polymer is incorporated by melt blending into melt-fabricable perfluoropolymer, such as tetrafluoroethylene/hexafluoropropylene copolymer or copolymer of tetrafluoroethylene with perfluoro(alkyl vinyl ether) such as perfluoro(ethyl vinyl ether), perfluoro(propyl vinyl ether) or a mixture of perfluoro(methyl and propyl vinyl ether).

### EXAMPLES

The particle size (diameter), referred to as RDPS (raw dispersion particle size) in the Examples, is determined by the laser light scattering method of ASTM D4464.

### Example 1

Polymerization is carried out in a stirred pressure vessel 10 gallons (40 liters) in capacity. Before use, the vessel is charged with 44 lbs (20 kg) of demineralized water, 5 g of ammonium persulfate, and 80 ml of a 20 wt % solution of ammonium perfluorooctanoate in water. The vessel is brought to a boil (100° C.) for 30 minutes. The contents are discharged.

The precharge for polymerization is:

Demineralized water, 40 lbs (18 kg);
Krytox® 157 FSL perfluoropolyether acid, 2 g;
Oxalic acid, 1.0 g;
Potassium metabisulfite, 0.2 g;
Succinic acid, 1.0 g;
Ammonium perfluorooctanoate, 300 ml of 20 wt % solution in water.

Initiator for the polymerization is potassium permanganate, 7.2 g with ammonium phosphate 1 g, per liter of demineralized water.

The vessel is charged with TFE, 10-15 psig (172-207 kPa) at 50° C., and evacuated. This is repeated twice so as to displace oxygen. The precharge is added, and then TFE is added to bring the pressure to 225 psig (1.65 MPa). Agitation (44 rpm) is begun. Initiator solution, 50 ml, is added at 50 ml/min, then 1 ml/min initiator solution addition is begun. Polymerization is considered to begin when vessel pressure has dropped 10 psi (70 kPa), at which point pressure is restored to 225 psig (1.65 MPa). Temperature of the vessel contents is controlled at 50° C., TFE feed is set at 0.06 lbs/min (27 g/min). The vessel is vented if necessary to maintain pressure at no more than 225 psig (1.65 MPa). After 15 minutes (core time), pressure is 150 psig (1.14 MPa) agitation is stopped and TFE and initiator solution feeds are stopped. The vessel is vented and evacuated, and cooled to 25° C. This completes the formation of the PTFE core.

The vessel is then charged with ethane to 8 inches Hg (27 kPa). The vessel is heated to 50° C. and charged with ethylene to increase pressure by 25 psi (170 kPa) and then add TFE to increase pressure to 225 psig (1.65 MPa). Begin agitation (44 rpm). Establish flow of ethylene to the vessel at 0.017 lb/min (7.7 g/min) and TFE at 0.06 lbs/min (27 g/min), venting if necessary to maintain pressure at 225 psig (1.65 MPa). These feeds of ethylene and TFE provide an ETFE copolymer containing about 50 mole % of each monomer (units derived from the copolymerization reaction). Inject 20 ml perfluoro(ethyl vinyl ether) (PEVE). Add 100 ml of initiator solution at 50 ml/min and then feed initiator solution at 2 ml/min. Polymerization is considered to begin when vessel pressure has dropped 10 psi (70 kPa), at which point pressure is restored to 225 psig (1.65 MPa) with TFE. Maintain temperature at 50° C. and begin PEVE feed at 0.9 ml/min. Continue polymerization for 220 minutes (shell time), then stop agitation, vent the vessel, and drain the contents. The weight of the resulting dispersion is 53.4 lbs (24 kg) and 22.3% solids. From monomer consumption, the core is found to be 12.6 wt % and the shell 87.4 wt % of the core/shell polymer. The RDPS of the PTFE core is 38 nm and the RDPS of the core/shell polymer is 76 nm.

### Example 2

Example 2 follows the procedure of Example 1 except that the core time is 5 minutes, and the shell time is 170 minutes. The resulting dispersion is 17% solids and the core is found to be 5.9 wt %, the shell being 94.1 wt % of the core/shell polymer. The RDPS of the core is 26 nm, and the RDPS of the core/shell polymer is 68 nm.

### Example 3

Polymerization is carried out in a stirred pressure vessel 10 gallons (40 liters) in capacity. Before use, the vessel is charged with 44 lbs (20 kg) of demineralized water, 5 g of ammonium persulfate, and 80 ml of a 20 wt % solution of ammonium perfluorooctanoate in water. The vessel is brought to a boil (100° C.) for 30 minutes. The contents are discharged.

The precharge for polymerization is:

Demineralized water, 40 lbs (18 kg);
Krytox® 157 FSL perfluoropolyether acid, 2 g;
Oxalic acid, 1.0 g;
Potassium metabisulfite, 0.2 g;
Succinic acid, 1.0 g;
Ammonium perfluorooctanoate, 300 ml of 20 wt % solution in water.

Initiator for the polymerization is potassium permanganate, 7.2 g with ammonium phosphate 1 g, per liter of demineralized water.

The vessel is charged with TFE, 10-15 psig (172-207 kPa) at 50° C., and evacuated. This is repeated twice so as to displace oxygen. The precharge is added, and then TFE is added to bring the pressure to 225 psig (1.65 MPa). Agitation (44 rpm) is begun. Initiator solution, 50 ml, is added at 50 ml/min, then 1 ml/min initiator solution addition is begun. Polymerization is considered to begin when vessel pressure has dropped 10 psi (70 kPa), at which point pressure is restored to 225 psig (1.65 MPa). Temperature of the vessel contents is controlled at 50° C., TFE feed is set at 0.06 lbs/min (27 g/min). The vessel is vented if necessary to maintain pressure at no more than 225 psig (1.65 MPa). After 30 minutes (core time), pressure is 109 psig (0.85 MPa) agitation is stopped and TFE and initiator solution feeds are stopped. The vessel is vented and evacuated, and cooled to 25° C. This completes the formation of the PTFE core.

The vessel is heated to 50° C. and charged with ethylene to increase pressure by 25 psi (170 kPa) and then add TFE to increase pressure to 225 psig (1.65 MPa). Begin agitation (44 rpm). Establish flow of ethylene to the vessel at 0.017 lb/min (7.7 g/min) and TFE at 0.06 lbs/min (27 g/min), venting if necessary to maintain pressure at 225 psig (1.65 MPa). Inject 20 ml perfluoro(ethyl vinyl ether) (PEVE). Add 100 ml of initiator solution at 50 ml/min and then feed initiator solution at 2 ml/min. Polymerization is considered to begin when vessel pressure has dropped 10 psi (70 kPa), at which point pressure is restored to 225 psig (1.65 MPa) with TFE. Maintain temperature at 50° C. and begin PEVE feed at 0.9 ml/min. Continue polymerization for 90 minutes (shell time), then stop agitation, vent the vessel, and drain the contents. The resulting dispersion is 18.66% solids. From monomer consumption, the core is found to be 27.3 wt % and the shell 72.7 wt % of the core/shell polymer. The RDPS of the core/shell polymer is 83 nm.

### Example 4

The procedure of Example 3 is repeated with the following changes: In the formation of the PTFE core (step (a)), the pressure is 104 psig (0.82 MPa) when agitation and monomer and initiator feeds are stopped. In the formation of the copolymer shell, the modifying monomer used is perfluorobutyl ethylene (PFBE) instead of PEVE and the polymerization vessel is then charged with ethane to 16 inches Hg (54 kPa). The resulting dispersion is 15.12 wt % polymer solids of which the core content is 35.2 wt % and the shell is 64.8 wt % of the core/shell polymer formed. The PFBE content of the copolymer shell is about 4 wt %.

For each of the Examples, the polymerizations were discontinued for economy of time. The aqueous dispersions obtained were free of coagulum. The dispersions were coagulated by freezing the dispersion, thawing it while resting on a filter, whereby the thawed liquid leaves the thawing dispersion as the liquid is formed, followed by drying to form a readily crumbed filter cake, i.e. a powder.

### Example 5

### Increasing the Flex Modulus of Perfluoropolymer

The perfluoropolymer used in this Example is a copolymer of TFE with 3.8 wt % PPVE having an MFR of about 14 g/10 min and is in the form of secondary particles (powder) having an average size of about 15 micrometers. By itself, this polymer exhibits a flex modulus of 655 MPa.

This perfluoropolymer (matrix polymer) powder is dry blended with the core/shell polymer of Example 3 in the following proportions: 25 wt % core/shell polymer and 75 wt % perfluoropolymer. The amount of PTFE and ETFE in this dry blend is 6.8 and 18.2 wt %, respectively, the remainder of the blend to total 100 wt % being the perfluoropolymer. The flex modulus of the PTFE of the core is 630 MPa and the flex modulus of the shell ETFE is 1320 MPa.

The flex modulus of this blend is 986 MPa. This is a 50% increase in flex modulus as compared to the perfluoropolymer by itself (calculation: [(986−655)+655]×100). This increase in flex modulus is much more than could be predicted from the flex moduli of the PTFE and ETFE blended with the perfluoropolymer. For example if the PTFE were taken to have the same flex modulus as the perfluoropolymer, then the expected contribution of the 18.2 wt % ETFE to the flex modulus of the blend can be estimated as follows: (18.2%×1320)+(81.8%×655)=776 MPa for blend, which is an 18.5% increase in flex modulus. The blend exceeds the predicted flex modulus by a factor of 2.7 (50%/18/5%).

Similar unexpected improvement is obtained when FEP is substituted for the TFE/PPVE copolymer as the matrix polymer.

The flex modulus is determined on compression molded plaques formed by the following procedure: The blend of matrix polymer powder and core/shell polymer powder is compressed under a force of 20,000 lbs (9070 kg) at a temperature of 350° C. to make 6×6 in (15.2×15.2 cm) compression moldings. In greater detail, to make the 60 mil thick plaque, the powder blend is added in an overflow amount to a chase which is 55 mil (1.4 mm) thick. The chase defines the 6×6 in sample size. To avoid sticking to the platens of the compression molding press, the chase and powder filling are sandwiched between two sheets of aluminum foil. The press platens are heated to 350° C. This sandwich is first pressed for 5 min at about 200 lb (91 kg) to melt the polymers of the powder blend and cause it to coalesce, followed by pressing at 10,000 lb (4500 kg) for 2 min, followed by 20000 lb (9070 kg) for 2 min, followed by release of the pressing force, removal of the compression molding from the chase and sheets of aluminum foil, and cooling in air under a weight to prevent warping of the plaque.

### Example 6

### Reducing the Flex Modulus of ETFE

The ETFE used in this Example is a copolymer of about equimolar amounts of ethylene and TFE, the copolymer also containing about 4 wt % copolymerized PFBE. This ETFE is in the form of secondary particles (powder). This ETFE by itself exhibits a flex modulus of 1320 MPa.

The ETFE of the preceding paragraph (matrix polymer) is dry blended with the core/shell polymer of Example 4 in the following proportions: 10 wt % core/shell polymer and 90 wt % matrix polymer. The amount of PTFE in this dry blend is about 3 wt %. The flex modulus of this blend is 855 MPa. The flex modulus of the PTFE of the core is about 630 MPa by itself. The flex modulus of the shell ETFE is also about 1320 MPa.

In another experiment, the matrix polymer is dry blended with the core/shell polymer of Example 4 in the following proportions: 25 wt % core/shell polymer and 75 wt % matrix polymer. The amount of PTFE in this blend is about 8 wt %. The flex modulus of this blend is 885 MPa.

The ETFE matrix polymer has an elongation (at break) of greater 300%. The reduction in flex modulus of the matrix polymer by the incorporation of the core/shell polymer does not reduce this elongation.

The elongation (at break) is determined by the procedure of ASTM D 638-03 on dumbbell-shaped test specimens 15 mm wide by 38 mm long and having a web thickness of 5 mm, stamped out from 60 mil (1.5 mm) thick compression molded plaques.

### Example 7

### Improved Limiting Oxygen Index (LOI)

Perfluoropolymers have high melting temperatures and high use temperatures for continued service. Polytetrafluoroethylene, which has such a high molecular weight, e.g. at least 1,000,000, that it does not flow when melted, melts at 327° C. (second melt) and has a use temperature of 260° C. Melt-fabricable perfluoropolymers, notably melt flowable copolymers of tetrafluoroethylene (TFE) with either hexafluoropropylene (HFP) or perfluoro(alkyl vinyl ether) (PAVE), such as perfluoro(ethyl or propyl vinyl ether), melt at about 260° C. and 310° C., respectively. TFE/HFP copolymers have a use temperature of 200° C., and TFE/PAVE copolymer has a use temperature of 260° C.

Melt flowable copolymers of ethylene with TFE, i.e. ETFE have been developed, which have a melt temperature of about 270° C. While this melt temperature is higher than that of TFE/HFP copolymer, the use temperature of ETFE is much lower, i.e. 150° C. The use temperature of ETFE is so low because of their flammability as characterized by limiting oxygen index (LOI). LOI determines the minimum concentration of oxygen that will support flaming combustion in a flowing mixture of oxygen and nitrogen. The higher the LOI, the higher the concentration of oxygen that is needed to support combustion, and the greater is the tendency towards nonflammability. The lower the LOI, the greater is the flammability of the polymer. The perfluoropolymers mentioned above all are highly non-flammable and have an LOI of at least 95. In contrast, the LOI of ETFE having the most typical ethylene content of about 50 mole % is only about 30. It has been found that the ethylene/tetrafluoroethylene, modifying vinyl monomer copolymers made by the process of the present invention, wherein the core polymer is non-melt flowable PTFE such as is prepared in Examples 1-3 has an unexpectedly high LOI, enabling these core/shell polymers to be useful in applications requiring greater inflammability and/or use temperature.

LOI is determined in accordance with the procedure of ASTM D 2863-06a, Procedure A/Test Method A on plaques molded from the test polymer, the plaques measuring 5 in×¼ in×⅛ in and being conditioned at 23° C. and 55% relative humidity for 88 hr just prior to test. Test polymer made of PTFE by itself exhibits an LOI of 95. Test polymer of the ethylene/tetrafluoroethylene/vinyl monomer copolymer polymer by itself exhibits an LOI of 30 to 31. The calculated LOI for the core/shell polymer is obtained by application of the rule of mixing. Sample calculation (for Example 1): 12.6 wt % core having LOI of 95+87.4 wt % shell having an LOI of 31=LOI of 39.

The LOI for the core/shell polymers of Examples 1-3 are as follows:

| Example | Measured LOI | Calculated LOI |
|---|---|---|
| 1 | 44 | 39 |
| 2 | 37.4 | 34.7 |
| 3 | 62 | 49 |

What is claimed is:

1. Process for polymerization to form a copolymer of ethylene/tetrafluoroethylene/modifying vinyl monomer providing a side chain containing at least two carbon atoms as a dispersion of particles of said copolymer in an aqueous medium, comprising (a) initiating said polymerization with at least one fluoromonomer that forms a stable dispersion of thermally stable polymer particles in said aqueous medium, said thermally stable polymer particles providing polymerization sites for further polymerization and (b) carrying out said further polymerization by copolymerizing said ethylene, tetrafluoroethylene, and modifying vinyl monomer in at least said aqueous medium to a polymer solids content of at least about 15 wt %, said copolymer comprising at least about 60 wt % of the total polymer content of said polymer solids.

2. The process of claim 1 wherein said polymerization of (a) and (b) is carried out in the presence of free-radical initiator and surfactant.

3. The process of claim 1 wherein said polymerization of (a) and (b) is carried out essentially in the absence of any organic solvent in said aqueous medium.

4. The process of claim 1 wherein said modifying vinyl monomer is (i) CF₂═CFOₓR, wherein x is an integer of 0 or 1 and R is an organic group containing at least 2 carbon atoms, (ii) CH₂═CHₓR′_{y}, wherein x is an integer of 0 or 1 and y is 2 or 1, respectively, and R′ is fluoroalkyl, and (iii) CH₂═CFR″ wherein R″ is fluoroalkyl.

5. The process of claim 1 wherein said fluoromonomer is perfluoromonomer.

6. An aqueous dispersion of the polymer solids of claim 1, said polymer solids having an average particle size of no greater than about 125 nm.

7. The aqueous dispersion of claim 6, wherein said average particle size is no greater than about 100 nm.
